(19) United States
(12) Patent Application Publication
(10) Pub. No.: US 2003/0083990 A1
(43) Pub. Date: May 1, 2003

(54) System and method for operating a charging system

(76) Inventors: Andreas Berg, Berlin (DE); Uwe Klatt, Berlin (DE); Thomas Ryll, Berlin (DE)

Correspondence Address: Kevin R. Spivak, Morrison & Foerster LLP, Suite 300, 1650 Tysons Boulevard, McLean, VA, 22102, US

(21) Appl. No.: 10/260,529

(22) Filed: Oct. 1, 2002

(30) Foreign Application Priority Data
Oct. 1, 2001 (DE) 10148540.9

(51) Int. Cl. G06F 17/60

(52) U.S. Cl. 705/40

(57) ABSTRACT

The invention relates to a system and method for operating a charging system for charging for the use of services and for the transmission of service data, using a terminal, a communications network having a network operator, where the charging system ascertains a use charge and a transmission charge before a service is used and before the service data are transmitted, ascertains a total charge by correlating the two charge types, and initiates a debit operation for the charges from a credit account belonging to a service user. The invention also illustrates a charging system for carrying out the method.

### CLAIM FOR PRIORITY

This application claims priority to Application No. 10148540.9 which was filed in the German language on Oct. 1, 2001.

### TECHNICAL FIELD OF THE INVENTION

The invention relates to a system and method for operating a charging system.

### BACKGROUND OF THE INVENTION

Service providers provide telecommunications services to service users whose terminals are connected to the service providers via a communications network. Normally, a use charge and a transmission charge are required for the use of a telecommunications service and for the service data transmission which is required for this purpose. To regulate the payment processes between the service provider and the service user, service providers regulating the payment process, namely payment service providers (PSP), access a credit account (prepaid account) belonging to the service user and debit the use and transmission charges incurred for use of the service. Alternatively, in a postpaid mode, the PSP can produce an invoice relating to the incurred use charges and transmission charges.

Since a network operator in a communications network produces, for the terminal, a monthly bill for the charges which are incurred for using the communications network, the PSP is normally arranged in the network operator in the communications network (particularly for mobile networks).

In addition, the service provider may be arranged within the network operator, so that the service users, who are already customers of the network operator, can be provided with telephone services, and the charges incurred for these services can be billed.

As the telecommunications market opens up, service providers and network operators are being isolated from one another. Hence, service providers which are not identical to the network operator are able to use the communications network to provide their own services as content providers. The PSPs are also arranged in the network operator devices. In this context, the network operator appears as a provider (access provider) of access to the provided services and regulates payment for the service with the service user on behalf of the service provider using the PSP. Generally, the transmission charge incurred for transmission of service data for using the service is billed in this manner.

By way of example, a service user wishes to use the service “send a picture electronically using a mobile terminal” by accessing a service provider. A use charge of [symbol] 1 is incurred for the use of this service. The terminal starts to transmit the picture via the mobile radio communications network. During the transmission, the volume of data to be transmitted is continually calculated by the network operator, and the appropriate transmission charge is debited from a credit account belonging to the service user. If the credit account prematurely reaches a zero level during this transmission procedure, that is the account contains no further credit, transmission of the service data is terminated. Hence, although the service user is charged for using the service, the service user cannot use the service fully since transmission of the service data is terminated on account of insufficient credit for the transmission charge incurred.

### SUMMARY OF THE INVENTION

The present invention provides a system and method for operating a charging system which allows for a reciprocal dependency between transmission charges incurred for transmitting service data and the use of a service.

In one embodiment of the invention, there is a method for operating a charging system for charging for the use of services provided by a service provider and for the transmission of service data, using a terminal used by a service user, using a communications network having a network operator, the charging system ascertains a use charge and a transmission charge before a service is used and before the service data are transmitted, establishes an included total charge by correlating the two charge types using suitable parameters, and initiates a debit operation for the correlating total charges from a credit account belonging to the service user. Alternatively, in a postpaid mode, an invoice can be produced for subsequent charge billing. This ensures that transmission of service data is not terminated owing to a credit account not having sufficient cover for the incurred transmission charge. Instead, the charging system is used to check for sufficient cover in the credit account before the service is actually used, which means that payment both of the use charge and of the transmission charge is ensured.

In accordance with one preferred embodiment, an initial charge is debited, or debiting thereof is initiated, from the credit account before the use charges and transmission charges are actually ascertained, the initial charge being used first for further transmissions of data. By way of example, this initial charge can be used to permit access to the services of a service provider in the first place by virtue of the service user registering with the service provider. In addition, the initial charge can be used for using or altering the content of free WEB/WAP pages. Such an initial charge, which is based on transmission of a particular volume of data, can be, by way of example, [symbol] 0.1 for transmitting a volume of data of 10 kB. Normally, transmission of a volume of data of 10 kB is provided by German network operators.

Preferably, every charging operation has a first identification number produced for it which is used in order to re-identify a charging procedure in the individual devices connected to the charging system. Specifically, in one embodiment, this involves a service provider which is connected directly to the charging system, the credit account, a control device for controlling the debit procedures and credit procedures on the account, and an interface which is used to allow a mobile terminal arranged outside the communications network to access the Hip-based communications network—such as the Internet—using GPRS (General Packet Radio Service). For this purpose, the interface comprises a supporting GPRS support node (SGSN) and a gateway GPRS support node (GGSN) which are connected to one another using a GPRS tunneling protocol (GTP).

Advantageously, the GGSN assigns an IP address to the mobile terminal when the terminal first accesses the communications network. The charging system uses this forwarded IP address (second identification number) to correlate the use charge and transmission charge.

In one aspect of the invention, when the initial charge has been debited, a connection is set up between the terminal and the service provider, particularly using a TCP/IP transmission protocol and a GTP protocol, for the service user to select a service. When the service user has selected a particular service, the service provider sends the charging system a message including details about the value of the use charge and/or the volume of data in the service data which are to be transmitted to the terminal, together with the second identification number. In this way, the charging system is provided with the data which are necessary for calculating the charges which will probably be incurred. A subsequent calculation, particularly of the transmission charges, results in the sum made up of the transmission charge and the use charge being debited from the credit account with or without the aid of the control device. When the charges have been debited is the service used by virtue of the service data being transmitted from the service provider to the terminal.

In another aspect of the invention, if the value of the previously debited transmission and use charges exceeds the value of the actually incurred charges when the use procedure has ended, a comparison performed using a comparison device arranged in the charging system is used to ascertain a difference value, and said difference value is credited to the credit account.

In another embodiment of the invention, there is a charging system including a reception device for receiving a use charge transmitted by a service provider and a calculation device for calculating a transmission charge from details transmitted by the service provider relating to the volume of data in service data which are to be transmitted to the terminal. In order to debit the incurred charges, the charging system is connected to the control device for controlling debit procedures and credit operations on a credit account.

### BRIEF DESCRIPTION OF THE DRAWINGS

The invention is described in more detail below with reference to the exemplary embodiments in conjunction with the drawings, in which:

FIG. 1 shows a schematic illustration of a first embodiment of the invention.

FIG. 2 shows a schematic illustration of a second embodiment of the invention.

### DETAILED DESCRIPTION OF THE PREFERRED EMBODIMENTS

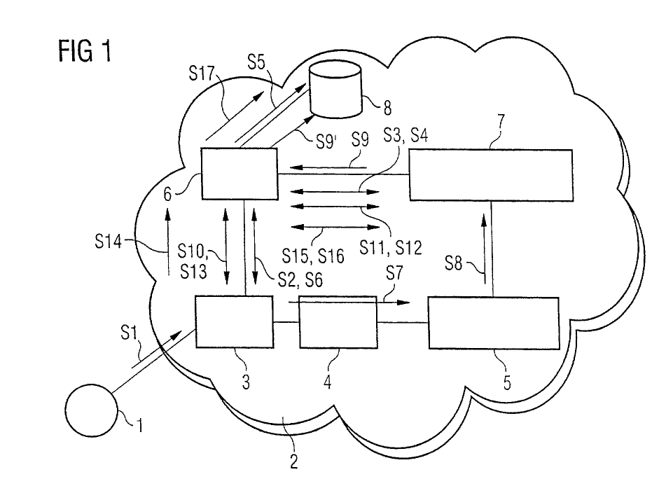

FIG. 1 shows a schematic illustration of the first embodiment of the invention. The user of a mobile terminal 1 uses his terminal to access a communications network 2 having a network operator, in order to use a service from a service provider. A method for packet-oriented data transmission (GPRS) is used to set up a connection to a supporting GPRS support node (SGSN) (S1).

In connection with the SGSN, a gateway GPRS support node (GGSN) 4 which communicates with the SGSN using a GPRS tunneling protocol (GTP) is used as an interface for accessing a service provider 5.

The service provider 5 is connected to the GGSN 4. In a step S2, a trigger which is set up and signaling system No 7 (SS7) in conjunction with the CAP protocol (CAMEL Application Part) are used to signal to a service control point, as network element (SCP), that a terminal intends to access a service. To this end, the SGSN sends the operation “Initial DP GPRS”, which contains parameters necessary for online charging.

In S3, on the basis of the MSIDSDN of the terminal 1, an “online” interface based on the TCP/IP protocol is used to send signaling from the SCP to a charging system 7 in order to prompt an initial charge as a reservation for imminent charging for the transmission of data. This is done by debiting the initial charge from a credit account 8.

In S4, the charging system uses an internal function to perform rating in order to implement the initial charge for initial reservation of a sum of money for the future transmission of data. In response to the rating, the charging system 7 opens a new transaction context for the charging procedure in connection with the use of the service, with parameters known in the transaction context (e.g. MSIDSDN of the terminal 1, value of the reserved charge, etc.) being recorded for this transaction. The value of the reserved charge, which corresponds to the initial charge, is sent together with a unique transaction identification number to the SCP, which controls the debit procedures on the charge account 8. The value of the reserved credit can be zero in this context.

In S5, the SCP debits the transmitted value for the initial charge from the internally managed credit account 8. The successful debit operation is reported to the charging system (not illustrated).

The SCP uses the operations “Applied Charging GPRS” and “Connect GPRS” to report the granted initial charge or the volume of data which can be transmitted with the granted initial charge to the SGSN. The volume of data can be 10 kB, for example. In addition, the transaction ID is forwarded to the SGSN as a parameter.

In S7, the user selects a provided service from the service provider 5 when a connection has been set up from the terminal 1 to the service provider 5 on the basis of a TCP/IP protocol. By way of example, this can be the provided service of an MP3 download, for which the service provider 5 requires a use charge of [symbol] 0.50. If the service user decides to use the provided service, an MP3 needs to be downloaded to his terminal at the use charge offered.

However, before the service provider 5 allows downloading, a message is used to send the charging system 7 the use charge for the service and further details relating to the service, such as details relating to the volume of data in the MP3 service data which are to be downloaded, together with the transaction identification number which is forwarded from the SGSN to the service provider 5.

In S9 and S9′, following calculation of the incurred transmission charges on the basis of the transmitted details, a sum total is ascertained which is sent to the SCP using a message in order to debit it from the credit account 8. Within the transaction context, the volume of data in the selected service remains stored.

By transmitting a message “Apply Charging Report”, in S10 the SGSN will send the SCP a request for allocating additional transmission charges or the associated volume of data, since the value of the already reserved transmission charges is generally exceeded by the use of the service provider.

In S11, the SCP sends a message to the charging system 7 which notifies the charging system that a larger volume of data is needed for use of the service than the volume of data provided by the initial charge. In S12, the charging system 7 asks the SCP to forward the already provided increased volume of data to the SGSN.

In S13, the SCP forwards the increased volume of data to the SGSN. When the charging process has ended, the SGSN sends a conclusion message to the SCP in S14 (“Apply Charging Report”).

In S15, the charging system 7 likewise receives a message about the conclusion of the charging process and produces a final bill relating to the actually incurred charges. In S16, the charging system 7 asks the SCP to credit the difference sum ascertained by comparison of the previously provided charges and the actually incurred charges back to the user's credit account. In S17, the SCP credits this difference sum back to the credit account 8.

The central arrangement of a charging system means that the previously required signaling complexity between the SGSN and the SCP is reduced, as a result of which the loading on the communications network and the costs incurred for the network operator are reduced.

Since any charging for a service in the credit account already contains the proportional transmission charges, it is possible to make the debit instructions on the credit account more understandable for the service user.

An example of application is used to describe the first embodiment of the inventive method again briefly:

In S2 to S6, the charging system 7 debits from the credit account 8 a charge of [symbol] 1, which corresponds to a volume of data which is to be transmitted of 10 kB. The SGSN is notified of this volume of data as a “granted volume”.

In S7, the service user uses the service provider 5 to select the service of sending an electronic postcard. In S8, the service provider 5 sends the charging system 7 a payment request message which is used to announce that the service user wishes to use the service and needs to pay [symbol] 3 for the service. In this case, the volume of data for the postcard which is to be transmitted is 50 kB. With this message, the service provider 5 sends a request to reserve the sum.

In S9 and S9′, the charging system recognizes from the forwarded transaction ID that a particular service user to whom an initial charge or an initial volume of data has already been ascribed is to use a service. To ensure that the service user can pay for use of the service, the charging system 7 first accesses the user's credit account 8 and debits the sum of [symbol] 3. Following successful debiting, the charging system 7 reports successful reservation of the sum to the service provider, and the service provider then adds the service data to be transmitted, with a volume of data of 50 kB, to the transaction context.

In S10 to S13, the SGSN requests, in addition to the initial volume of data, a further provided volume of data for transmitting data comprising a volume of data of 50 kB. The charging system makes this increased volume of data or the transmission charge available.

In S14, following the conclusion of successful use of the service, a message is sent from the service provider 5 to the charging system 7, which message is used to announce successful use of the service. The service provider 5 is then credited with the reserved sum.

In addition, the service provider can send details about the actually sent volume of data to the charging system. If a difference sum is established, this volume of data instructs the SCP to credit this difference sum to the user's credit account.

In S15 to S17, the difference sum is first calculated in a final bill. To this end, the actually required volume of data (53 kB), including the service use (50 kB) and the request for the service from the service provider and also the rest of the process for using the service (3 kB), is indicated. Accordingly, the service user needs to be credited with that sum which corresponds to the unused volume of data, amounting to the remaining 7 kB, that is to say [symbol] 0.7. The credit account now has a debit entry of [symbol] 3 for the use of the postcard service and [symbol] 0.3 for the transmission before and after use of the service.

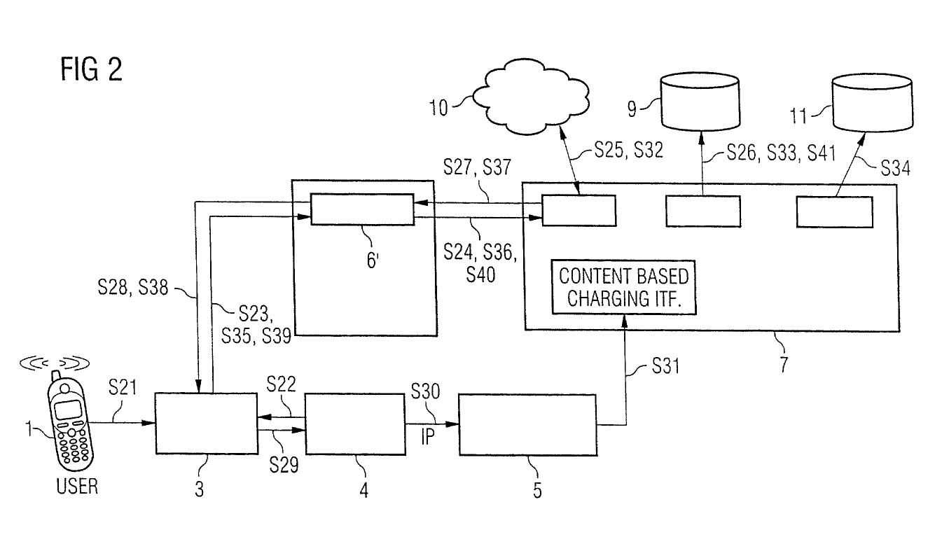

The second embodiment of the invention, shown in FIG. 2, is made up of the method in accordance with the first embodiment. In S21, the terminal 1 accesses the network operator's network via the SGSN 3 and the GGSN 4. In S22, the GGSN allocates an IP address to the service user and returns it to the SGSN.

In S23, a trigger is used to notify a Parlay gateway 6′, as control device, of the access to the network by the terminal 1. This is again done using signaling system No 7 (SS7) and using the CAP protocol.

In S24, online charging information relating to the transmission of data and the IP address of the service user is forwarded to the charging system 7. For this purpose, the Parlay gateway supports the “Data Session Control” function from the “Open Service Access (OSA)” standard in UMTS Release 4, 3GPP TS 29.198-8.

In S25, the charging system 7 again uses an internal function to perform the rating. For this purpose, the charging system 7 accesses the rating parameters C.

In S26, the initial charge is debited by accessing a prepaid system 9 which manages the user's accounts.

In S27, the charging system 7 instructs the Parlay gateway 6′, using the Parlay/OSA method “superviseDataSession” and the parameter “granted Volume”, what volume of data is initially to be made available to the service user.

In S28, the Parlay gateway converts this received method into the operation “Apply Charging GPRS” and “Connect GPRS” and reports the approved volume of data to the SGSN 3. This volume of data can be 10 kB, for example.

In S29, the SGSN uses the GTP protocol to set up the actual data link to the GGSN. The service user can now access the service provider 5 via an Internet Protocol (IP) link. In S30, the service user then selects an appropriate service in the manner already described. Before the service provider 5 permits downloading of the service data by the terminal 1, a message is sent to the charging system via a “Content Based Charging” interface, which is used to provide further details about the volume of data in the service data which are to be downloaded. The service provider and the charging system 7 support the “Content Based Charging” interface, which is defined in the “Open Service Access (OSA)” standard in UMTS Release 4, 3GPP TS 29.198-12.

Optionally, the service provider can be authenticated and authorized using the Parlay/OSA framework in the charging system in order to ensure that the service provider is authorized to use the charging system.

In S32, the sum total of the incurred charges is calculated in the manner already described. This sum is then debited from the credit account in S33. Alternatively, in a step S34, an invoice can be produced for subsequent billing (postpaid) using the ticket data base L.

In S35 and S36, the SGSN uses the message “Apply Charging Report” to ask the Parlay gateway 6′ again to provide an additional volume of data in the form of transmission charges, and the Parlay gateway 6′ uses the method “supervisedDataSessionRes” to notify the charging system 7 of this request.

In S37 and S38, the charging system 7 uses the method “supervisedDataSessionRequest” to ask the Parlay gateway 6′ to forward the increased volume of data to the SGSN, whereupon the Parlay gateway 6′ forwards the increased volume of data.

In S39, following the conclusion of use of the service, the SGSN sends a conclusion message to the Parlay gateway (“Apply Charging Report”), and in S40 the charging system 7 is notified of conclusion of the use of the service. In S41, the charging system 7 credits the difference sum to the credit account in the manner already described, using the prepaid system 9.

What is claimed is:

1. A method of operating a charging system for charging for use of services provided by a service provider and for transmission of service data, comprising:
ascertaining a use charge and a transmission charge before a service is used and before the service data are transmitted;
correlating the use charge and the service charge to form total charges; and
initiating a debit operation for the total charges from a credit account belonging to a service user, or initiating an invoicing operation for subsequent charge billing.

2. The method as claimed in claim 1, wherein the charging system debits or initiates debits for an initial charge for transmissions of additional data and/or for use of additional services from the credit account before the use charges and transmission charges are ascertained.

3. The method as claimed in claim 1, wherein the charging system assigns a first identification number to charging operations for the use of services and the transmission of service data.

4. The method as claimed in claim 3, wherein the identification number and the value of the initial charge are transmitted from the charging system to a control device to control the charge debit operations from the credit account.

5. The method as claimed in claim 2, wherein when the initial charge has been debited, a connection is set up between the terminal and the service provider for the service user to select a service.

6. The method as claimed in claim 5, wherein after setup of the connection and before use of the service by the service user, the service provider sends the charging system a message including details about a value of the use charge and/or a volume of data in the service data which are to be transmitted to the terminal, and a second identification number associated with the terminal.

7. The method as claimed in claim 6, wherein the charging system calculates the transmission charge from the details transmitted with the message and prompts or executes a debit operation for the total charge ascertained by correlating the transmission charge and the use charge.

8. The method as claimed in claim 1, wherein the terminal is connected to the communications network via an interface.

9. The method as claimed in claim 8, wherein upon conclusion of use of the service, the values stored in the interface for the initial charge and the calculated transmission charge are compared with the value of the charges which have actually been incurred.

10. The method as claimed in claim 9, wherein a difference value for the charges which results from the comparison is credited to the credit account.

11. A charging system for charging for use of services provided by a service provider and for transmission of service data, comprising:
a reception device to receive details transmitted by a service provider regarding a value of a use charge and/or a volume of data in the service data which are to be transmitted to a terminal; and
a calculation device to calculate a transmission charge from transmitted details relating to the volume of data in the service data which are to be transmitted.

12. The charging system as claimed in claim 11, wherein the charging system is connected to a control device to control debit and credit procedures on a credit account.
